(19) United States
(12) Patent Application Publication
(10) Pub. No.: US 2005/0122581 A1
(43) Pub. Date: Jun. 9, 2005

(54) Binoculars, particularly pocket binoculars

(76) Inventors: Dirk Luthardt, Wetzlar (DE); Gerd Polzer, Wetzlar (DE); Martin Rademacher, Grossheirath (DE); Davor Pavlic, Coburg (DE); Gerd Malter, Effelder-Rauenstein (DE)

Correspondence Address: M. Robert Kestenbaum, 11011 Bermuda Dunes NE, Albuquerque, NM, 87111, US

(21) Appl. No.: 10/696,674

(22) Filed: Oct. 27, 2003

Related U.S. Application Data
(63) Continuation of application No. PCT/EP02/04568, filed on Apr. 25, 2002.

(30) Foreign Application Priority Data
Apr. 27, 2001 (DE) 101 21 075.2
Oct. 27, 2001 (DE) 101 53 167.2

(51) Int. Cl. G02B 23/00

(52) U.S. Cl. 359/410; 359/407

(57) ABSTRACT

A pair of binoculars includes a rotating element. When the rotating element is actuated, the lens of the binoculars, which are used for focusing, are displaced. The lenses are mounted in an axially displaceable manner. A rotating movement initiated by the rotating element is translated into a rotating movement with a larger angle of rotation by means of a gear transmission stage.

### CROSS-REFERENCES TO RELATED APPLICATIONS

This is a Continuation of International Patent Application PCT/EP02/04568 filed 25 Apr. 2002, which claims priority of German Patent Applications DE 101 21 075.2 filed 27 Apr. 2001 and DE 101 53 167.2 filed 27 Oct. 2001.

### STATEMENT REGARDING FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISC

Not applicable.

### BACKGROUND OF THE INVENTION

1. Field of the Invention

The invention relates to binoculars, particularly pocket binoculars with a rotary element, by the actuation of which axially displaceable lenses are displaced for focusing. Description of Related Art including information discussed under 37 CFR 1.97 and 1.98

From German Patent Document DE 41 25 584, a binocular telescope or binoculars is known that has a focusing drive wheel which is rotated for focusing. The focusing drive wheel is provided with an internal thread formed as a screw thread. This helical gearing is in engagement with an external toothing of a bridge portion. The bridge portion is mounted for axial displacement and rotationally fixed, so that by rotation of the focusing drive wheel an axial movement of the bridge portion results. Push rods are fixedly connected to the bridge portion. Focusing lenses or focusing lens groups are axially positively connected to these push rods by means of catches.

With this construction, it is disadvantageous that the adjustment path of the focusing lenses or focusing optics which can be attained with corresponding constructional size and comfortable operation is limited in the axial direction by this construction. In order to make focusing possible over a large range of distance, however, it is necessary that the focusing lenses can also move through a large adjustment path in the axial direction.

### SUMMARY OF THE INVENTION

The invention has as its object to further develop a binoculars so that the range over which it can be focused is enlarged, with comfortable operation and compact structure.

By the measure of providing a binoculars with a rotary element so that, from a rotary movement of the rotary element by means of a gear toothing, an axial movement results of lenses mounted for axial displacement and provided for focusing, and wherein the rotary element is in operative connection with the helical gearing by means of the interposition of a gear transmission stage, an enlargement can be provided of the possible adjustment path of the focusing lenses in the axial direction. By means of the gear transmission stage, the rotary movement of the rotary element is converted into a multiple rotation of the element provided with the helical gearing.

By the use of this gear transmission stage, it is thus possible to attain an increase of the focusing range above the range which could be attained for technical reasons by a maximum possible or reasonable increase of the pitch of the screw thread.

In particular, there is an effect on the ease of operation which can be provided by this enlarged axial adjustment path of the focusing lenses without the rotation angle to be turned through by the rotary element having to be increased. The whole focusing range can be traveled without the user having to frequently change his grip.

The object of the invention is furthermore attained by the use of the gear transmission stage that sensitive focusing is furthermore possible in spite of a large focusing range. In particular, it has been found to be advantageous to embody this gear transmission stage in two stages. With such multi-stage gear transmission stages, a desired sensitivity can be more favorably attained, particularly with little available constructional space.

It has been found to be advantageous to use a gear transmission stage whose drive takeoff portion turns through at least a multiple of the angular path, particularly twice the angular path, of the input portion of the gear transmission stage, here the rotary element. The maximum possible focusing range is thereby increased by a factor of two, two and a half, three, etc.

It has been found to be advantageous that the drive takeoff portion of the gear transmission stage performs at most the fourfold angular path of the rotary element. It is thereby ensured that focusing by means of the rotary element can be sufficiently sensitive. In particular, it is possible to provide by means of the invention a sensitivity of at least 12.5, where the sensitivity is given by:

$$\frac{Actuation - path}{Drive - takeoff - path} = Sensitivity$$

It has been found to be advantageous to arrange the gear transmission stage within the rotary element, so that a compact binoculars, particularly pocket binoculars, can be provided.

Spur gears and planetary gears and friction gears, which can be arranged in a particularly space-saving manner in the rotary element, have been found to be particularly suitable as the gear transmission stage.

It has furthermore been found to be advantageous to provide a central adjustment shaft with which the lenses of the focusing device are positively, axially in operative connection. It has been found to be advantageous to arrange the adjustment shaft on the hinge axis of the binoculars. In a particularly compact embodiment example, the adjustment shaft is mounted in a hinge bushing of the binoculars.

### BRIEF DESCRIPTION OF THE SEVERAL VIEWS OF THE DRAWINGS

The invention is described in detail using the following embodiment:

FIG. 1 shows a binoculars;

FIG. 2 shows a cross section along B-B as shown in FIG. 6, through the hinge axis of the binoculars;

FIG. 3 shows a rotary element with gear transmission stage, in longitudinal section;

FIG. 4 shows a sectional diagram through the rotary element along E-E;

FIG. 5 shows a sectional diagram through the rotary element along D-D;

FIG. 6 shows a sectional diagram through the rotary element along G-G; and

FIG. 7 shows a sectional diagram through the rotary element along H-H.

### DETAILED DESCRIPTION OF THE INVENTION

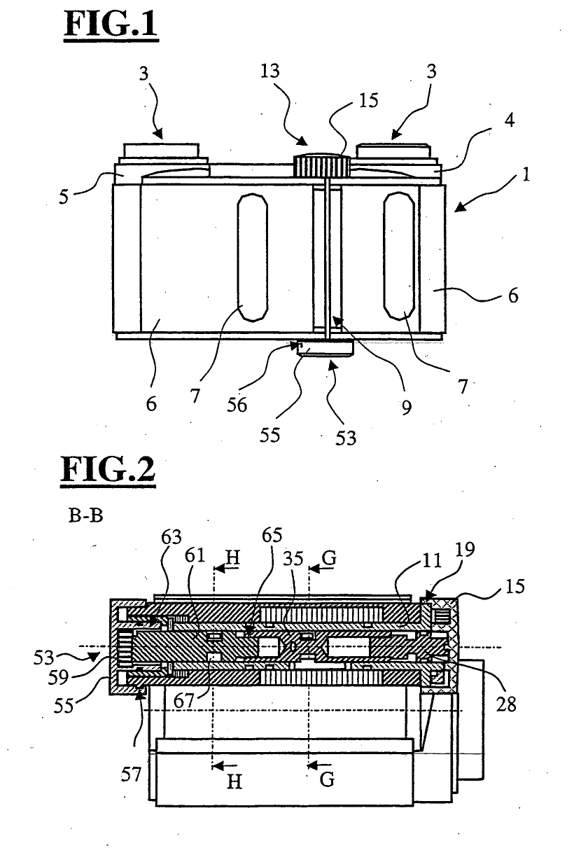

The principal structure of the binoculars 1 is next described using FIG. 1. The housing of the binoculars 1 is in two portions, with a first housing portion 4 and a further housing portion 5. Both housing portions are mounted rotatably on the hinge bushing 11 (see FIG. 2). The relative distance of the eyepiece 3 or of the optical axes allocated to the eyepieces 3 of the binoculars 1 is variable by turning the housing portions 4, 5 relative to each other. These housing portions in which the grip recesses 7 are formed are denoted by reference numeral 6.

Operating elements are arranged at both ends of the hinge shaft 9. The operating element on the user's side, here a rotary element 15, is a component of a focusing device 13. The operating element arranged at the opposite end of the hinge shaft 9, here a rotary knob 55, is a component of a diopter compensation 53. The arrangement of this operating element is also possible in a reversed arrangement. Furthermore, the arrangement of the operating elements on another position on the hinge shaft is possible.

The housing portions 4, 5 of the binoculars 1 are respectively provided on the outside with a protective covering 6 in which grip recesses 7 are formed.

A section through the hinge shaft 9 is shown in FIG. 2. The manner of functioning of the focusing device 13 and of the diopter compensation 53 is described using this FIG. 2. The focusing device 13 has a rotary element 15, which is provided with an inner toothing, here a spur toothing. This toothing is in engagement with an external toothing of a ring 21 which is toothed internally and externally. This internally and externally toothed ring 21 is in engagement with an outer toothing of a spur wheel 29. Instead of the spur gearing, helical gearing could also be provided here.

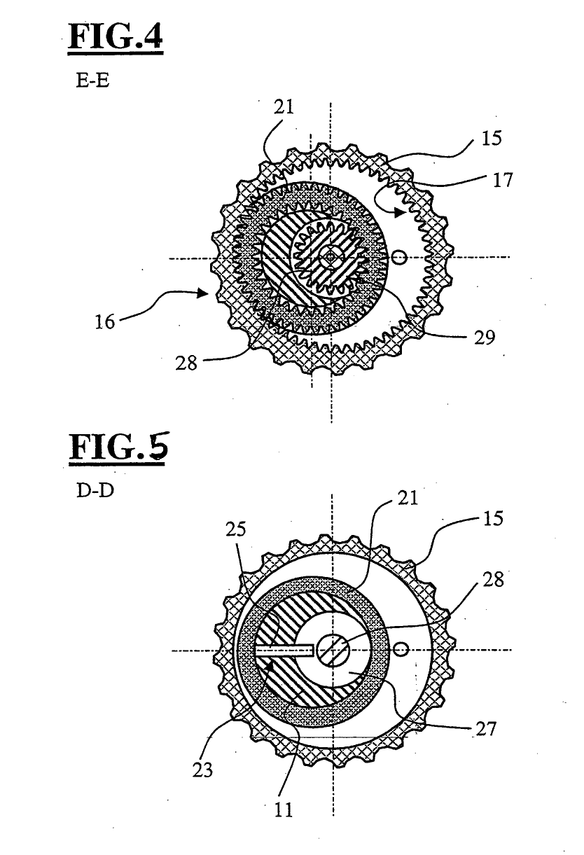

The arrangement of rotary element 15, internally and externally toothed ring 21, and sun wheel 29, which functions as the drive takeoff portion 28 of the gear transmission stage 16, can be seen particularly clearly in FIG. 4. In the embodiment example shown, the rotary element 15 has an internal toothing with 56 teeth. The internally and externally toothed ring 21 has an external toothing with 44 teeth and an internal toothing with 32 teeth. The sun wheel 29 is provided with an external toothing with 20 teeth. The overall resulting gear ratio is 2.04. A desired gear transmission ratio can be achieved by selection of the tooth ratios of the toothings of the rotary element 15, internally and externally toothed ring 21, and sum wheel 29.

With this transmission ratio, the sensitivity is 12.5, so that the lens is displaced in the axial direction by 0.08 mm with an actuation path of 1 mm in arcuate measure at the rotary knob. This adjustment path of the focusing lens corresponds to 0.5 diopters. The maximum adjustment path of the focusing lenses is 5.6 mm, which corresponds to a rotation of 445° at the rotary element.

An axial securement 23, as shown in FIG. 5, is provided for axial fixing of the drive portion 28 with gear wheel. For axial securement, a pin 25 engages in an annular groove 27 formed in the drive takeoff portion 28. The pin 25 is fixedly connected to the hinge bushing 11. The axial securement of the internally and externally toothed ring 21 takes place by means of the rotary element 15 which is axially mounted on the hinge bushing 11. The internally and externally toothed ring 21 itself is radially mounted on the hinge bushing 11, which is formed eccentrically in this region. It is thereby ensured that the internally and eternally toothed ring 21 is always in engagement, on the one hand with the toothing of the rotary element 15 and on the other hand with the toothing of the sun wheel 29.

The sun wheel 29 is arranged coaxially of the hinge shaft 9 of the binoculars 1. The rotary element 15 is mounted at the end by means of an inward-facing projection of the rotary element 15 which engages in a recess formed in the sun wheel 29. The sun wheel 29 has a shaft extension 31 which is mounted in a hinge bushing 11 arranged coaxially of the hinge shaft 9. The shaft extension 31 is provided with a helical gearing 33 which is in engagement with a helical gearing 37 formed on the adjustment shaft 35. The adjustment shaft 35 is likewise mounted in the hinge bushing 11.

In the embodiment shown, the helical gearing 37 formed in the adjustment shaft 35 is formed as an internal thread, the helical gearing 33 of the shaft extension 31 being formed a an external thread. It is however likewise possible to exchange the arrangement of the helical gearings 33, 37 of the adjustment shaft 35 and shaft extension 31, so that the adjustment shaft would be formed with an external thread, which engages in a recess of the shaft extension provided with an internal thread.

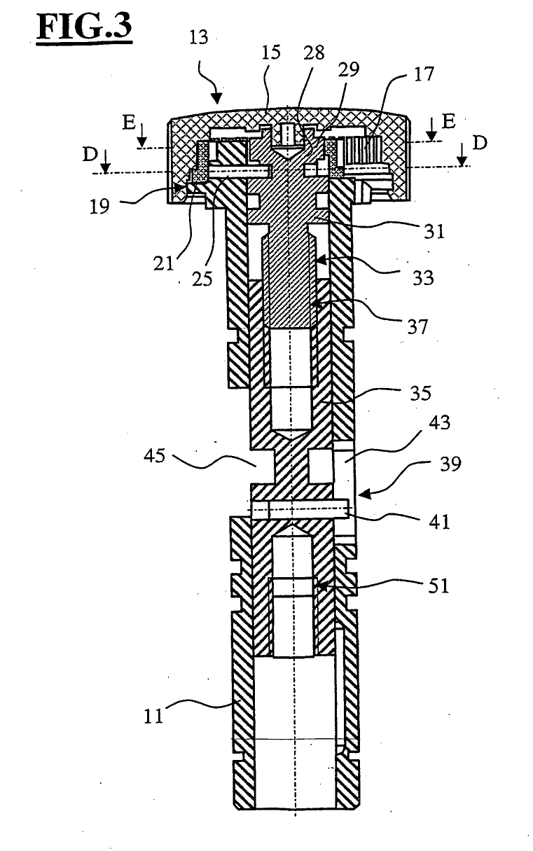

The adjustment shaft 35 mounted in the hinge bushing 11 is axially displaceable and is secured against rotary movements by a rotation securement 39. A pin 41 is provided as the rotation securement, and is fixedly connected to the adjustment shaft 35. This pin engages in a longitudinal slot 43 formed in the hinge bushing 11. This arrangement can be seen particularly clearly in FIG. 3.

The adjustment shaft 35 is provided with a further helical gearing 51 on the end of the adjustment shaft 35 remote from the rotary element 15. This helical gearing 51 is again formed as an internal thread. A helical gearing 65 of a shaft 61 engages in this helical gearing 51. If the shaft 61 is driven in rotation, the shaft 61 is screwed into or out of the adjustment shaft 35, according to the direction of rotation. This shaft 61 is to be allocated to diopter compensation. This shaft 61 is also mounted in the hinge bushing 11. This shaft 61 is provided at the end with a spur toothing 63, which engages in a spur toothing 59 of the rotary knob 55 of the diopter compensation 53. By rotating the rotary knob 55, the shaft 61 is set in rotation because of the longitudinal toothings 59 and 63, which are in engagement. The rotary knob 55 is provided with an axial securement 57, and also the rotary element is provided with an axial securement 19. Both rotary knobs 15 and 55 here snap into an annular groove formed in the hinge bushing and are thereby axially fixed to the hinge bushing 11.

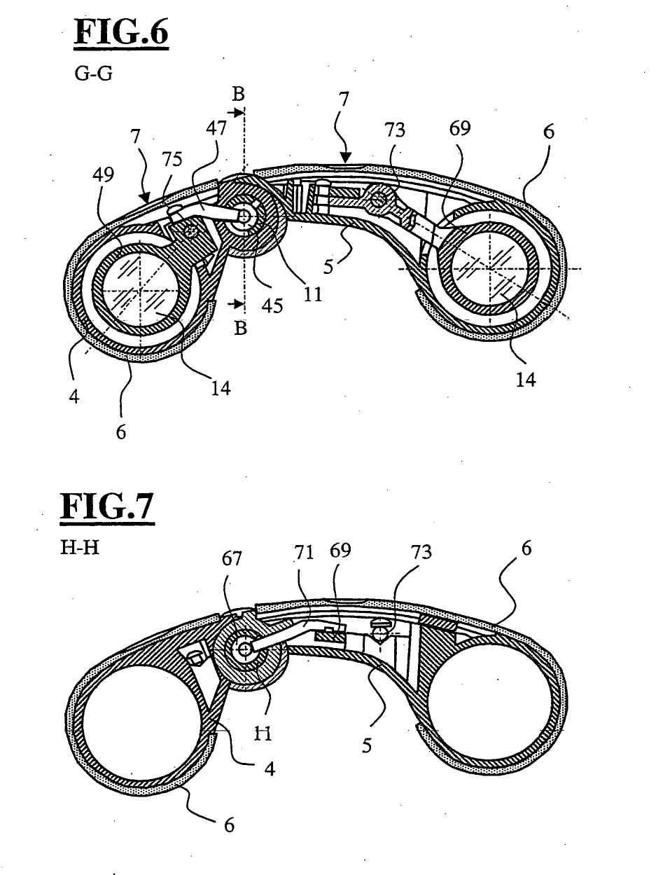

If now a rotary movement is initiated by means of the rotary element 15, the adjustment shaft 35 executes an axial movement together with the shaft 61. As can be gathered from FIG. 6, an engagement element 47 positively engages axially in an annular groove 45 formed in the adjustment shaft 35. This engagement element 47 is fixedly connected to a lens mount 49. This lens mount 49 carries a lens 14 which is displaced in an axial direction during focusing. The lens mount 49 is mounted, displaceable axially, on a mounting shaft 75. A further engagement element 71 positively engages axially in an annular groove 67 formed in the shaft 61. This engagement element 71 is fixedly connected to a lens mount 69 which is mounted, displaceable axially, on a bearing shaft 73. This lens mount 69 carries a further lens 14, which is likewise displaced in an axial direction for focusing. This lens is however also displaceable in the axial direction by actuation of the rotary knob 55 of the diopter compensation 53, the relative distance of the two lenses 14 being changed on operation of the diopter compensation.

1. Binoculars, particularly pocket binoculars, with a rotary element, by the actuation of which axially displaceable lenses are displaced for focusing, wherein the rotary movement introduced by the rotary element (15) is converted into a rotary movement with a greater rotation angle by means of a gear transmission stage (16).

2. Binoculars according to claim 1, wherein the rotary element (15) comprises an input portion of the gear transmission stage (16), and wherein on rotation of the rotary element (15) a drive takeoff portion (28) of the gear transmission stage (16) turns through at least twice the angular path.

3. Binoculars according to claim 1, wherein the drive takeoff portion (28) of the gear transmission stage (16) passes over at most four times the angular path of the rotary element (15).

4. Binoculars according to claim 1, wherein the gear transmission stage (16) comprises a sun wheel (29) which is connected to the rotary element (15) via an internal and externally toothed ring (21).

5. Binoculars according to claim 1, wherein the gear transmission stage (16) comprises a spur gearing or a planetary gearing, the planet wheels of which are mounted stationary and rotatably.

6. Binoculars according to claim 1, wherein the gear transmission stage (16) is arranged in the rotary element (15).

7. Binoculars according to claim 4, wherein the drive takeoff portion of the gear transmission stage (16) is fixedly connected to a shaft extension (31).

8. Binoculars according to claim 1, with a rotary element, by the acuation of which axially displaceable lenses are displaced for focusing, wherein a central adjustment shaft (35) is provided which executes, on actuation of the rotary element (15), an axial movement which corresponds to the axial movement of the lenses (14).

9. Binoculars according to claim 1, wherein the displacement shaft (35) is arranged on a hinge shaft (9) of the binoculars (1).

10. Binoculars according to claim 9, wherein the adjustment shaft (35) is mounted, displaceable axially, in a hinge bushing (11).

11. Binoculars according to claim 8, wherein the adjustment shaft (35) is provided with a rotation securement (39).

12. Binoculars according to claim 7, wherein the adjustment shaft (35) is provided at both ends with a helical gearing (51, 65).

13. Binoculars according to claim 1, wherein the adjustment shaft (35) is in operative connection with a shaft (61) of a diopter compensation (53).
